(19) United States
(12) Patent Application Publication
(10) Pub. No.: US 2017/0083232 A1
(43) Pub. Date: Mar. 23, 2017

(54) DUAL DISPLAY DEVICE

(71) Applicant: Microsoft Technology Licensing, LLC, Redmond, WA (US)

(72) Inventors: John Franciscus Marie Helmes, Steyl (NL); James Scott, Cambridge (GB); Stephen Edward Hodges, Cambridge (GB); Urho Konttori, Helsinki (FI); Nicholas Yen-Cherng Chen, Cambridge (GB); Stuart Alastair Taylor, Cambridge (GB); Pascal Knierim, Munich (DE); Gavin Wood, Newcastle Upon Tyne (GB); Josh Wolff Fromm, Seattle, WA (US)

(21) Appl. No.: 14/863,031

(22) Filed: Sep. 23, 2015

(51) Int. Cl. G06F 3/0488; G06F 3/0484

(52) U.S. Cl. CPC G06F 3/04886; G06F 3/04842

(57) ABSTRACT

A display device has both an emissive display and an electronic paper display. The electronic paper display is used for rendering visually static user input controls and a portion of the emissive display which is close to the electronic paper display is used for rendering visually dynamic user input controls. Also described are covers for an emissive display device, the covers comprising an electronic paper display device, and an emissive display device.

### BACKGROUND

Tablet computers and smartphones have a touch-sensitive display to enable a user to provide inputs to software running on the devices by touching the screen. To enable a user to provide text inputs, a keyboard is displayed on the lower half of the display and a user can type on this keyboard as if it was a physical keyboard. This type of keyboard is often referred to as a ‘soft keyboard’ to distinguish it from a physical (hardware) keyboard and because the keys are rendered by software as part of the user interface of the device.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A display device has both an emissive display and an electronic paper display. The electronic paper display is used for rendering visually static user input controls and a portion of the emissive display which is close to the electronic paper display is used for rendering visually dynamic user input controls. Also described are covers for an emissive display device, the covers comprising an electronic paper display device, and an emissive display device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows two schematic diagrams of an example dual display device;

FIG. 2 is a flow diagram showing an example method of operation of the dual display device of FIG. 1;

FIG. 3 is a flow diagram showing another example method of operation of the dual display device of FIG. 1;

FIG. 4 shows two schematic diagrams of an example cover for a touch-sensitive emissive display device;

FIG. 5 shows two schematic diagrams of another example cover for a touch-sensitive emissive display device;

FIG. 6 is a flow diagram showing an example method of operation of the cover of FIG. 4 or 5;

FIG. 7 is a flow diagram showing another example method of operation of the cover of FIG. 4 or 5;

FIG. 8 shows schematic diagrams of an example emissive display device and removable cover;

FIG. 9 is a flow diagram showing an example method of operation of the emissive display device of FIG. 8; and

FIG. 10 is a flow diagram showing another example method of operation of the emissive display device of FIG. 8.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Tablet computers and smartphones typically comprise an emissive display, such as a backlit liquid crystal display (LCDs) or LED display. Such displays provide a bright display which can easily be viewed in low ambient light levels and the emissive displays have a high refresh rate which has the effect that the user interface can update quickly to reflect each user touch input. Emissive displays require power to be able to display content and so the battery life is relatively limited (dependent upon battery size and how the device is actually used) and must be recharged regularly.

In contrast, e-reader devices often use a bi-stable display because they have much lower power consumption than LCD or LED displays. Unlike an emissive display, a bi-stable display requires power to change state (i.e. change the image/text displayed) but does not require power to maintain a static display. This enables the display to be “always on” (i.e. always displaying content, in contrast to emissive displays which typically have a power saving mode when the display is switched off). Although such e-reader devices do not need to be recharged as frequently as a device which comprises an emissive display, they still need to be recharged occasionally (e.g. every few weeks). Bi-stable displays typically have a much slower refresh rate and/or a longer refresh time (i.e. the time taken to perform a refresh of the display) and this can lead to a user noticing the delay (or lag) associated with updating the content.

The embodiments described below are not limited to implementations that solve any or all of the disadvantages of known display devices.

Described herein is a dual display device which comprises both an emissive display and an electronic paper display, in various examples, neither of these displays are touch-sensitive but instead include an alternative user input mechanism (e.g. voice, gestures, mouse, stylus, etc.). In other examples, one or both of the displays are touch-sensitive. A processor within the dual display device runs user input software (e.g. a keyboard application which provides inputs to other applications running on the device which may be a standalone application or part of the operating system) which renders visually static controls (i.e. visually static user selectable elements) on the electronic paper display and renders dynamic controls (i.e. visually dynamic user selectable elements) on a portion of the emissive display which is close (e.g. adjacent) to the electronic paper display.

In an example implementation, the visually static controls comprise the letter keys of a keyboard and the dynamic controls comprise dynamically generated and user selectable content suggestions. The dynamically generated content suggestions are generated as a consequence of a user's key strokes (on the letter keys on electronic paper display) but are additional to the characters represented by the key strokes alone (i.e. the content suggestions do not just correspond to the user's exact key strokes).

The term ‘key stroke’ is used herein to refer to the action of a user touching a displayed control where this touch may be a swipe, a tap or take any other form. The term ‘clicking’ is also used herein in relation to the controls displayed on one of the displays and this also is used herein to refer to the action of a user touching a displayed control where this touch may be a swipe, a tap or take any other form. The term ‘selecting’ is used herein to refer to the action of a user to touch or otherwise identify a user input control via a touch-sensitive display or an alternative user input mechanism.

Described herein is also a removable cover for an emissive display device which comprises a mechanical arrangement for receiving (e.g. for holding securely) the emissive display device (e.g. a tablet or smartphone) or otherwise connecting to the emissive display device and an electronic paper display (which may be touch-sensitive or the cover may comprise an alternative user input mechanism). A processor within the cover runs user input software (e.g. a keyboard application which provides inputs to applications running on the emissive display device) which renders visually static controls on the electronic paper display and provides data to the emissive display device to cause it to render dynamic controls on a portion of the emissive display close (e.g. adjacent) to the electronic paper display.

Described herein is also an emissive display device which comprises an interface to a removable cover, the cover comprising an electronic paper display (which may be touch-sensitive or the cover may comprise an alternative user input mechanism). A processor within the emissive display device runs user input software (e.g. a keyboard application which provides inputs to other applications running on the device which may be a standalone application or part of the operating system) which renders dynamic controls (i.e. visually dynamic user selectable elements) on a portion of the emissive display close (e.g. adjacent) to the electronic paper display and provides an output to the removable cover to cause the rendering of visually static controls (i.e. visually static user selectable elements) on the electronic paper display. In such an example, the removable cover comprises the electronic paper display and associated driver electronics and an interface for communicating with the emissive display device. If the electronic paper display is not touch-sensitive, the removable cover comprises an alternative user input mechanism (e.g. which uses voices, gestures, mouse, stylus, etc.).

As described above, the dual display device, removable cover and emissive display device all divide the user input controls between an emissive display and an electronic paper display based on the visual nature of the individual user input controls, i.e. whether the input controls are static or dynamic, where the term ‘static’ is used to refer to a user control which does not visually change very frequently (e.g. such as a letter key on a soft keyboard) and the term ‘dynamic’ is used to refer to a user control which changes frequently and in response to user inputs via the user input controls (e.g. such as a dynamically generated content suggestion). The input controls that change visually only infrequently (the visually static input controls) are rendered on the electronic paper display which has a slower refresh rate and the input controls which change visually more often (the dynamic input controls) are rendered on the emissive touch-sensitive display which has a much higher refresh rate. Similarly, input controls which require color and/or high resolution may be rendered on the emissive display and not on the electronic paper display as the characteristics of the input controls are better matched to the display characteristics of the emissive display.

By using an electronic paper display to render the visually static controls (e.g. the soft keyboard), rather than rendering it on half of the emissive display, the soft keys can be larger, which makes it easier and more natural for a user to type (which may be particularly useful for smaller devices, such as smart phones or smaller tablet computers where mistyping may frequently occur due to the small size of the soft keys) and the area of the emissive display which is available for rendering content to the user is much larger (as described previously, typically a soft keyboard takes up about half the emissive display area when it is visible). Furthermore, by using the emissive display to render the dynamic controls (e.g. dynamically generated content suggestions), rather than rendering them on the electronic paper display, the dynamic controls can be updated more quickly and/or more often (e.g. dynamic content suggestions can be rendered more quickly) as the refresh rate of the emissive display is much higher than the refresh rate of the electronic paper display. This means that, for example, a user does not experience any delay (or lag) between key strokes and the appearance of corresponding dynamically generated content suggestions.

By using a combination of an emissive display and an electronic paper display, the overall weight, thickness and power consumption of the dual display device or the removable cover, when fitted with (or otherwise connected to) an emissive display device, is reduced compared to a dual device comprising two emissive displays. Typically an emissive display is thicker and heavier than electronic paper display due to the different technologies which are used (e.g. an electronic paper display device may, for example, be only 1 mm thick and may, in various examples, be formed on a flexible substrate, whereas even a thin emissive display is at least 2-3 mm thick). Similarly, an electronic paper display has a much lower power consumption than an emissive display, particularly when being used to render a user interface that does not change often (e.g. a soft keyboard which may change to display lower/upper case letters or change to meet the specific preferences of a user, but typically does not change often). Furthermore an electronic paper display is more robust and easier to read in direct sunlight than an emissive display.

The term “electronic paper” is used herein to refer to display technologies which reflect light (like paper) instead of emitting light like conventional LCD displays. As they are reflective, electronic paper displays do not require a significant amount of power to maintain an image on the display and so may be described as persistent displays. A multi-stable display is an example of an electronic paper display. In some display devices, an electronic paper display may be used together with light generation in order to enable a user to more easily read the display when ambient light levels are too low (e.g. when it is dark). In such examples, the light generation is used to illuminate the electronic paper display to improve its visibility rather than being part of the image display mechanism and the electronic paper does not require light to be emitted in order to function.

The term “multi-stable display” is used herein to describe a display which comprises pixels that can move between two or more stable states (e.g. a black state and a white state and/or a series of grey or colored states). Bi-stable displays, which comprise pixels having two stable states, are therefore examples of multi-stable displays. A multi-stable display can be updated when powered, but holds a static image when not powered and as a result can display static images for long periods of time with minimal or no external power. Consequently, a multi-stable display may also be referred to as a “persistent display” or “persistently stable” display. An electrophoretic ink layer is an example of a multi-stable layer which can be changed (or controlled) by applying electric fields. Other examples include a cholesteric liquid crystal layer or a bi-stable electrowetting display layer which is controlled using electric fields or currents applied via electrodes on the faces of a the layer.

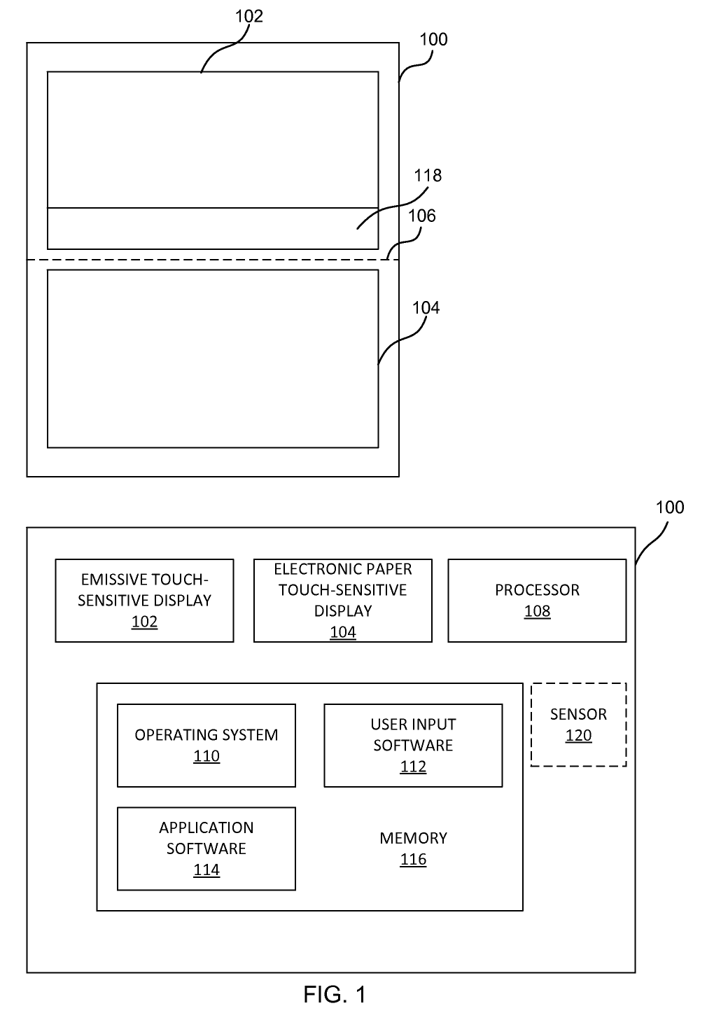

FIG. 1 shows two schematic diagrams of an example dual display device 100 which comprises both a touch-sensitive emissive display 102 and a touch-sensitive electronic paper display 104. The two displays are positioned adjacent to each other and in the example shown each display is rectangular and of a similar size, with the two arranged such that a long side of one display is parallel and close to a long side of the other display. In other examples they may alternatively be positioned such that a short side of one display is parallel and close to a short side of the other display or the displays may be square (rather than rectangular) or of different sizes. In some examples, the upper and lower halves of the dual display device 100 may be rigid (each half comprising one of the two displays) and the device 100 may comprise a fold or bend (indicated by the dotted line 106) so that it can be folded in half and/or so that the displays can be angled for ease of viewing or use. In other examples, the lower half (comprising the electronic paper display 104) may be flexible.

The dual display device 100 may have many different form factors (e.g. with different sizes and/or orientations of displays as described above). In various examples, the dual display device 100 is a handheld device. In various examples, the dual display device 100 may comprise a kickstand so that one of the displays (e.g. the emissive touch-sensitive display 102) can be supported in an angled position when the other display (e.g. the electronic paper touch-sensitive display 104) is resting on a surface.

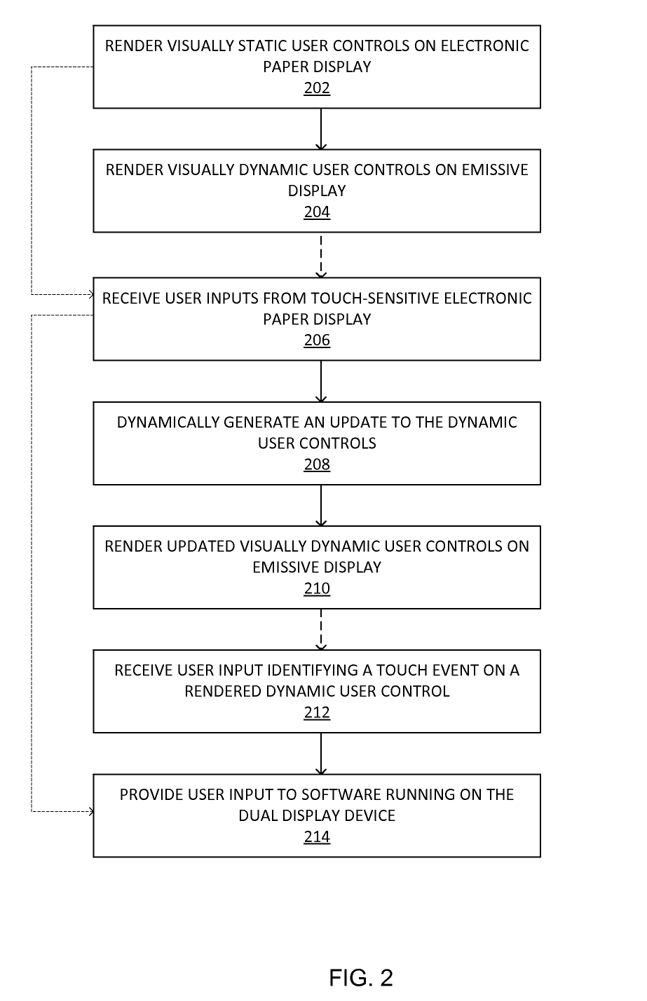

The dual display 100 further comprises a processor 108 and platform software comprising an operating system 110 (or any other suitable platform software) to enable user input software 112 (e.g. keyboard software) and application software 114 to be executed on the device 100. The software 110-114 may be stored in memory 116. The operation of the user input software 112 (when executed by the processor 108) can be described with reference to FIG. 2.

FIG. 2 is a flow diagram showing an example method of operation of the dual display device 100 (and in particular the user input software 112 when executed by the processor 108). As shown in FIG. 2, visually static user controls are rendered on the electronic paper display (block 202) and visually dynamic user controls are rendered on a portion 118 of the touch-sensitive emissive display 102 (block 204). As shown in FIG. 1, the portion 118 of the touch-sensitive emissive display 102 on which the dynamic user controls are rendered is adjacent to the electronic paper display 104. As described above, the electronic paper display 104 is touch-sensitive and subsequently, in response to receiving user inputs from the touch-sensitive electronic paper display 104 (block 206), where these inputs correspond to a user touching one or more of the rendered visually static user controls, updates to the dynamic user controls are dynamically generated based, at least in part, on the received user inputs (block 208). The updated visually dynamic user controls are then rendered on the emissive display (block 210).

The updating of the dynamic user controls (in block 208) in response to the received user inputs (in block 206) may be in addition to also providing the received user inputs to application software 114 or other software (e.g. the operating system 110) running on the dual display device 100 (block 214). Furthermore, in response to receiving user inputs from the emissive display (block 212), where these inputs correspond to a user touching one or more of the rendered visually dynamic user controls, these user inputs are provided to software running on the dual display device (block 214).

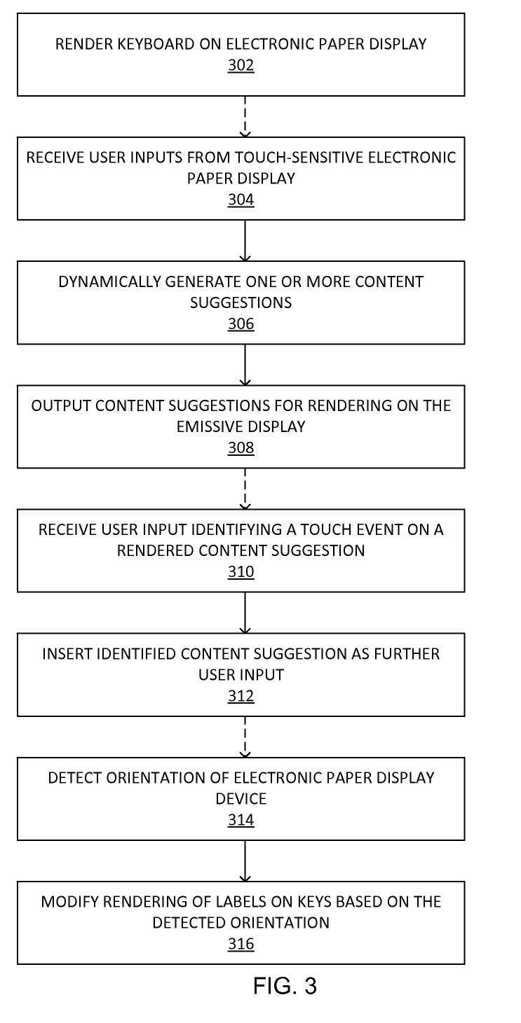

In various examples, as described above, the visually static user controls may comprise the letter keys of a keyboard and the dynamic user controls may comprise dynamically generated content suggestions. As shown in FIG. 3, in such examples, a soft keyboard is rendered on the electronic paper display 104 (block 302). As described above, this electronic paper display 104 is touch-sensitive and subsequently, in response to receiving user inputs from the touch-sensitive electronic paper display 104 (block 304), one or more content suggestions are dynamically generated based, at least in part, on the received user inputs (block 306). These content suggestions are then output for rendering on a portion 118 of the touch-sensitive emissive display 102 (block 308). As shown in FIG. 1, the portion 118 of the touch-sensitive emissive display 102 on which the content suggestions are rendered is adjacent to the electronic paper display 104.

Each of the rendered content suggestions (as rendered following block 308) forms a soft control (or button) on the touch-screen emissive display 102 and a user can select a content suggestion to be used (e.g. inserted into an application which is running on the dual display device 100). In response to receiving a user input from the touch-screen emissive display 102 indicating that a user has touched one of the content suggestions (block 310), the particular content suggestion is inserted into the application with which the user is currently interacting (block 312), i.e. the application which is currently receiving inputs corresponding to the key strokes made by the user on the soft keyboard rendered on the electronic paper display 104.

The content suggestions which are dynamically generated (in block 306) based on the previously received user key strokes may take many different forms. As described above, a dynamically generated content suggestion does not correspond exactly to the user's key strokes but includes one or more additional characters or may be completely different from the user's key strokes and various examples are described below.

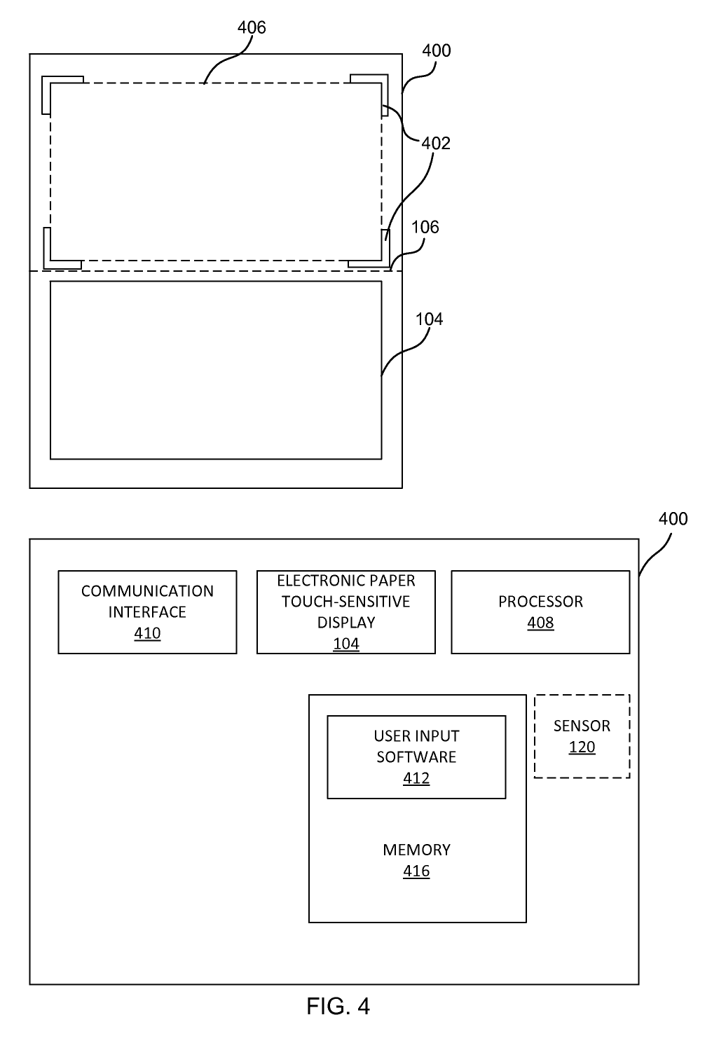

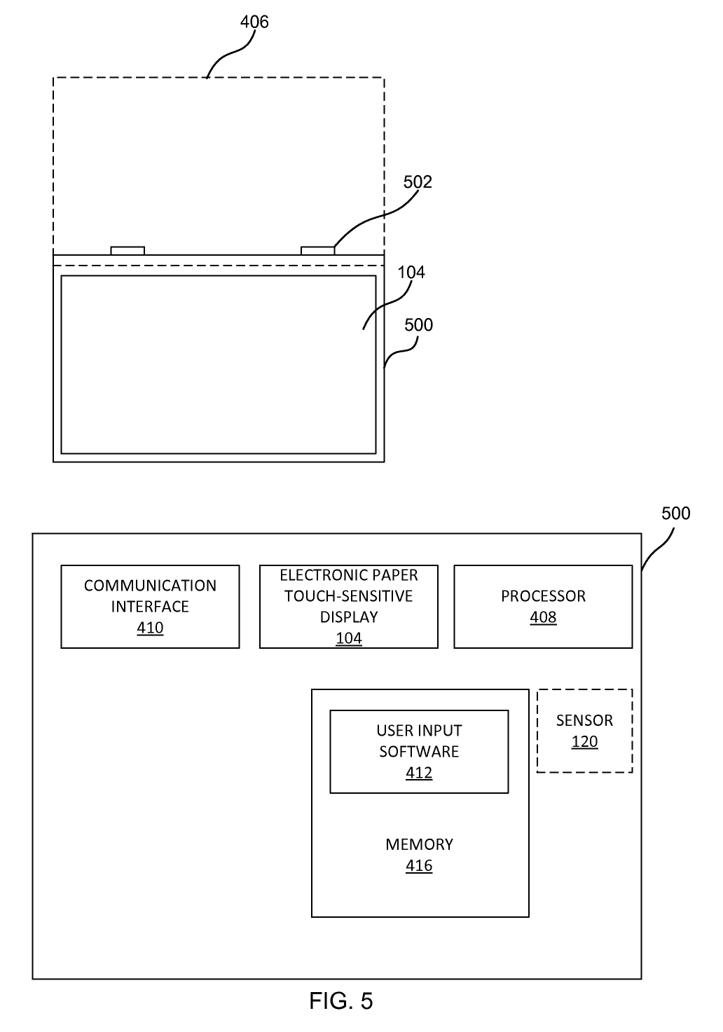

FIG. 4 shows two schematic diagrams of an example removable cover 400 (e.g. a flip or folio cover) for a touch-sensitive emissive display device. The cover 400 comprises a touch-sensitive electronic paper display 104 and a mechanism for removably attaching it to the touch-sensitive emissive display device. This mechanism may comprise a mechanical arrangement for receiving the touch-sensitive emissive display device such as a recess, slot or plurality of clips (e.g. such as the corner clips 402 shown in FIG. 4). The mechanical arrangement holds the touch-sensitive emissive display device in a pre-defined position on the cover 400 (indicated by the dotted outline 406) so that the touch-sensitive emissive display device and the cover 400 are mechanically connected together and a user can pick up the cover without the emissive display device falling out. Alternatively, the mechanism for removably attaching the cover 500 to the touch-sensitive emissive display device may comprise a connector 502 for attaching it to the emissive display device (indicated by the dotted outline 406) where this connector may use magnets, clips or any form of connector, as shown in FIG. 5.

When inserted in the mechanical arrangement or connected using the connector 502, the emissive display device is positioned adjacent to the electronic paper display 104 and in the example shown each display is rectangular and of a similar size, with the two arranged such that a long side of one display is parallel and close to a long side of the other display. In other examples they may alternatively be positioned such that a short side of one display is parallel and close to a short side of the other display or the displays may be square (rather than rectangular) and/or of different sizes. In some examples, the upper and lower halves of the cover 400 may be rigid and the device 400 may comprise a fold or bend (indicated by the dotted line 106) so that it can be folded in half and/or so that the displays can be angled for ease of viewing or use. Depending upon the connector 502 which is used, the cover 500 shown in FIG. 5 may also comprise a similar fold or the folding mechanism may be integrated into the connector design. In other examples, the lower half of the cover 400 shown in FIG. 4 or the entire cover 500 shown in FIG. 5 (comprising the electronic paper display 104) may be flexible.

The cover 400, 500 further comprises a processor 408, a communication interface 410 to enable the cover to communicate with an attached emissive display device and user input software 412 which may be stored in memory 416. The communication interface 410 may use any suitable wired or wireless protocol to communicate with the emissive display device (e.g. Wi-Fi™, Bluetooth™, and serial UART). Whilst use of a wireless communication interface may simplify the design of the attachment mechanism (e.g. clips 402 or connector 502) and enable use of the electronic paper display even when detached from the emissive display device, a wireless connection may typically have a slower data rate than a wired connection and increase the power consumption of the devices (i.e. of the emissive display device and/or the cover 400, 500).

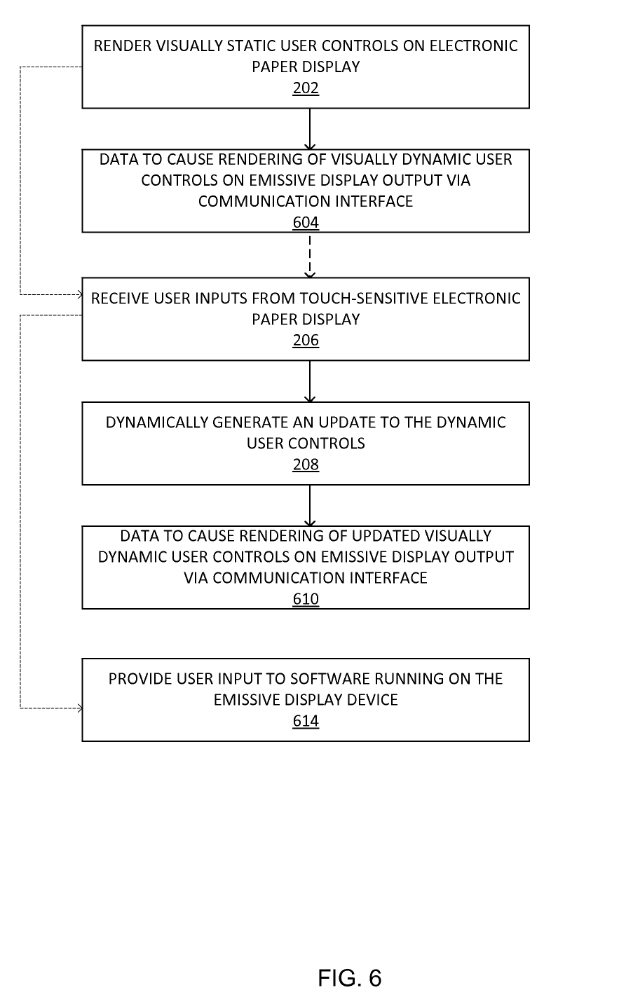

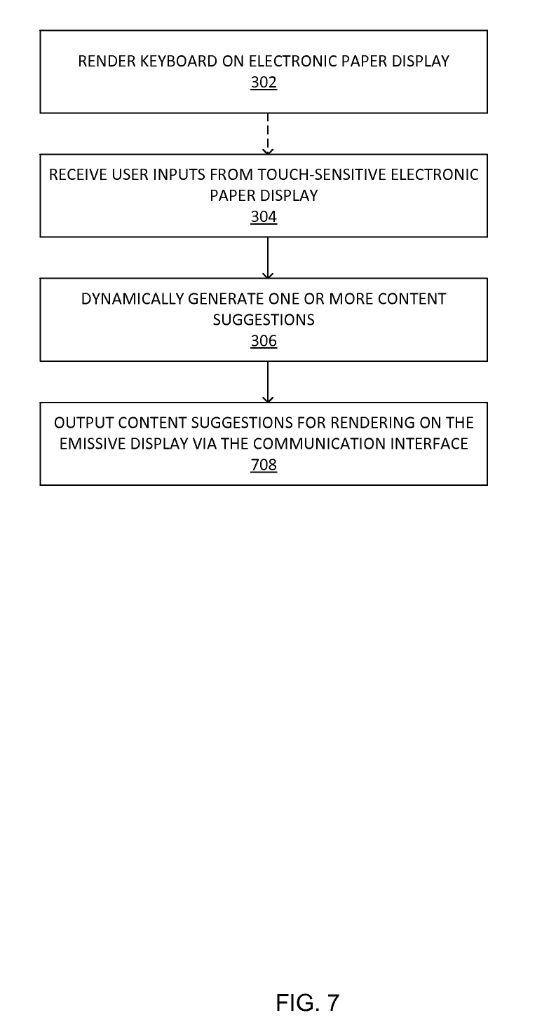

The operation of the user interface software 412 (when executed by the processor 408) can be described with reference to FIG. 6 or 7, which are variations on the methods shown in FIGS. 2 and 3 (described above). FIGS. 6 and 7 show example methods of operation of the cover 400, 500 (and in particular the user input software 412 when executed by the processor 408).

As shown in FIG. 6, static user controls are rendered on the electronic paper display 104 (block 202) and data to enable visually dynamic user controls to be rendered on the emissive display device are output, via the communication interface 410, to the emissive display device (block 602). Subsequently, in response to receiving user inputs from the touch-sensitive electronic paper display 104 (block 206), updates the dynamic user controls are generated (block 208) and data relating to these updates are output to the emissive display (via the communication interface 410) so that the updates can be rendered on the emissive display (block 610). As described above with reference to FIG. 2, the updating of the dynamic user controls (in block 208) in response to the received user inputs (in block 206) may be in addition to also providing the received user inputs to application software or other software (e.g. the operating system) running on the emissive display device 100 (block 614), via the communication interface 410.

As shown in FIG. 7, the visually static user controls may comprise a soft keyboard which rendered on the electronic paper display 104 (block 302). As described above, this electronic paper display 104 is touch-sensitive and subsequently, in response to receiving user inputs from the touch-sensitive electronic paper display 104 (block 304), one or more content suggestions are dynamically generated based, at least in part, on the received user inputs (block 306). These content suggestions are then output for rendering on a portion of the touch-sensitive emissive display 102 (block 708) via the communication interface 410. In a similar manner to that shown in FIG. 1 and described above, the portion of the touch-sensitive emissive display (when attached to the cover) on which the content suggestions are rendered is adjacent to the electronic paper display 104.

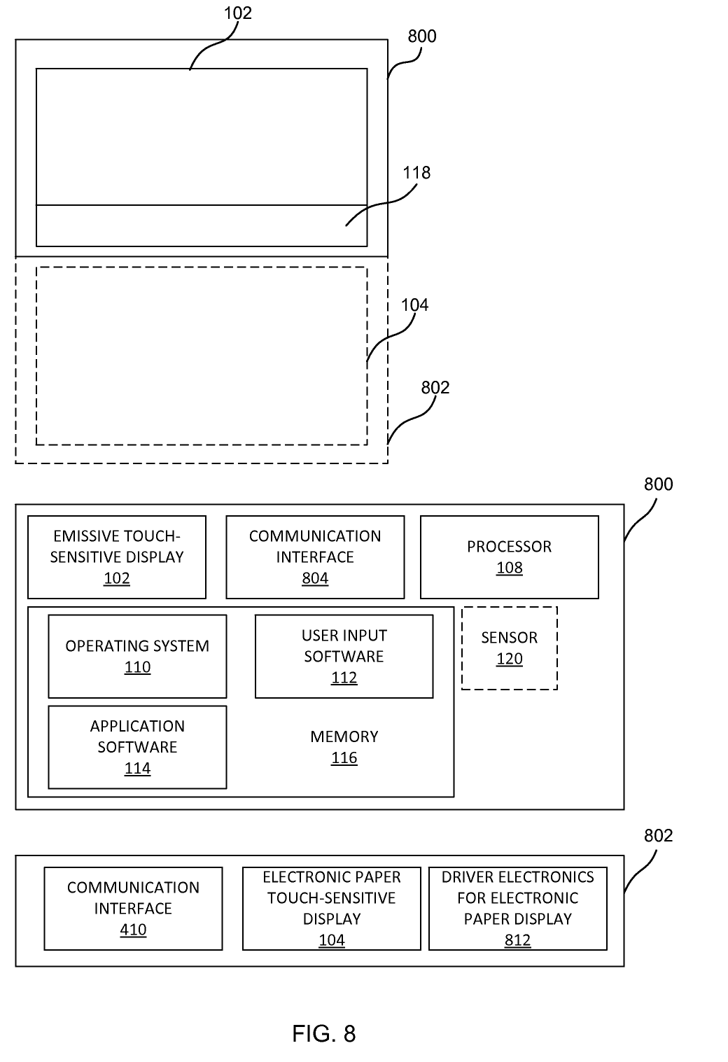

FIG. 8 shows two schematic diagrams of an example emissive display device 800 which can be connected to a removable cover 802 comprising an electronic paper touch-sensitive display 104. The removable cover 802 may have a similar physical form factor to the covers 400, 500 shown in FIGS. 4 and 5 (e.g. with clips 302 or connectors 502); however, the cover 802 does not run the user input software 112 and this is instead run on a processor 108 in the emissive display device 800. As shown in FIG. 8, the cover 802 comprises a communication interface 410 via which it receives messages relating to the visually static user input controls which are to be displayed on the electronic paper display 104 and these controls are rendered by the driver electronics for the electronic paper display 812. The emissive display device 800 is similar to the dual display device 100 described above and shown in FIG. 1; however, the emissive display device 800 does not comprise the electronic paper touch-sensitive display 104 which is instead in the cover 802. The user input software 112 which runs on the processor 108 in the emissive display device 800 provides output to the cover 802, via a communication interface 804, such that the visually static user input controls are rendered on the electronic paper display 104 and inputs from the electronic paper display 104 are also received by the emissive display device 800 via the communication interface 804.

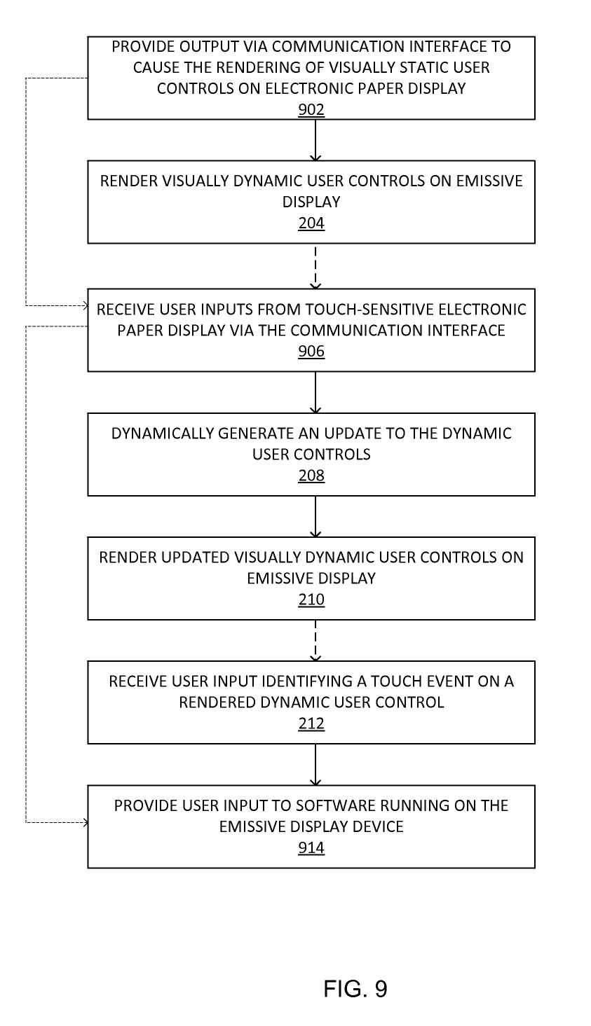

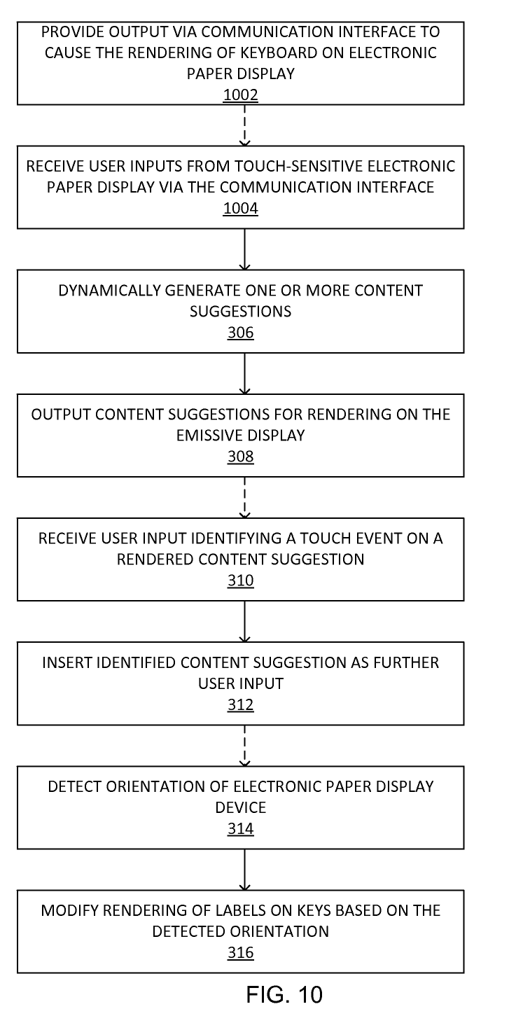

The operation of the emissive display device 800 (and in particular the user input software 112 when executed by the processor 108) can be described with reference to FIG. 9 or 10 (which are variations on the methods shown in FIGS. 2, 3, 6 and 7, described above). As shown in FIG. 8, messages to cause the rendering of the visually static user controls is output to the cover 802 via the communication interface 804 (block 902) and visually dynamic user controls are rendered on a portion 118 of the touch-sensitive emissive display 102 (block 204). As described above, the electronic paper display 104 is touch-sensitive and subsequently, in response to receiving user inputs from the touch-sensitive electronic paper display 104 via the communication interface 802 (block 906), where these inputs correspond to a user touching one or more of the rendered visually static user controls, updates to the dynamic user controls are dynamically generated based, at least in part, on the received user inputs (block 208). The updated visually dynamic user controls are then rendered on the emissive display (block 210).

The updating of the dynamic user controls (in block 208) in response to the received user inputs (in block 906) may be in addition to also providing the received user inputs to application software 114 or other software (e.g. the operating system 110) running on the emissive display device 100 (block 914). Furthermore, in response to receiving user inputs from the emissive display (block 212), where these inputs correspond to a user touching one or more of the rendered visually dynamic user controls, these user inputs are provided to software running on the emissive display device (block 914).

In various examples, as described above, the visually static user controls may comprise the letter keys of a keyboard and the dynamic user controls may comprise dynamically generated content suggestions. As shown in FIG. 10, in such examples, messages to cause the rendering of a soft keyboard on the electronic paper display 104 is output to the cover 802 via the communication interface 804 (block 1002). As described above, this electronic paper display 104 is touch-sensitive and subsequently, in response to receiving user inputs from the touch-sensitive electronic paper display 104 in the cover 802 via the communication interface 802 (block 1004), one or more content suggestions are dynamically generated based, at least in part, on the received user inputs (block 306). These content suggestions are then output for rendering on a portion 118 of the touch-sensitive emissive display 102 (block 308). As shown in FIG. 1, the portion 118 of the touch-sensitive emissive display 102 on which the content suggestions are rendered is adjacent to the electronic paper display 104.

Each of the rendered content suggestions (as rendered following block 308) forms a soft control (or button) on the touch-screen emissive display 102 and a user can select a content suggestion to be used (e.g. inserted into an application which is running on the emissive display device 800). In response to receiving a user input from the touch-screen emissive display 102 indicating that a user has touched one of the content suggestions (block 310), the particular content suggestion is inserted into the application with which the user is currently interacting (block 312), i.e. the application which is currently receiving inputs corresponding to the key strokes made by the user on the soft keyboard rendered on the electronic paper display 104.

The content suggestions which are dynamically generated (in block 306) based on the previously received user key strokes may take many different forms. As described above, a dynamically generated content suggestion does not correspond exactly to the user's key strokes but includes one or more additional characters or may be completely different from the user's key strokes and various examples are described below.

As can be seen from FIGS. 1, 4, 5 and 8, in all the implementations described herein a user can view both the emissive display and the electronic paper display at the same time. In various examples, the two displays may be in the same plane and in other examples (e.g. when the user has angled one of the displays manually or using a kickstand) there may be an angle of less than or more than 180° between the two display faces.

The visually dynamic user controls which are rendered on the emissive display (e.g. in blocks 204 and 604 in FIGS. 2, 6 and 9) and subsequently updated (e.g. in block 208 in FIGS. 2, 6 and 9) based on previously received user inputs via the electronic paper display (e.g. as received in blocks 206 and 906 in FIGS. 2, 6 and 9) may take many different forms. In various examples, as described with reference to FIGS. 3, 7 and 10, they may comprise content suggestions which are dynamically generated (e.g. in block 306 in FIGS. 3, 7 and 10) based on the previously received user key strokes (e.g. as received in block 310 in FIGS. 3, 7 and 10) and depending upon the particular type of content suggestion, the software may generate a single content suggestion or a plurality of content suggestions. As described above, each content suggestion does not correspond exactly to the user's key strokes but includes an additional character or may be completely different from the user's key strokes and various examples are described below.

In any of the examples described above (i.e. the dual display device 100, the covers 300, 400 and the emissive display device 800), the dynamically generated content suggestions may, for example, comprise one or more of:
auto-complete suggestions;
auto-correct suggestions, where these may span more than one word (e.g. a user typing “and the” may result in the dynamically generated content suggestion of “and the”);
a paste buffer;
translations of words or phrases into another language;
dictionary definitions of words;
emoticons;
pictorial or symbolic icons which the user may wish to substitute for text or add to text; and
expansion of system-defined or user-defined abbreviations,
   and these are described in more detail below.

In various examples, the dynamically generated content suggestions may comprise auto-complete suggestions for one or more words based on the text input by a user (i.e. based on the user's key strokes) on the soft keyboard on the electronic paper display 104. These auto-complete suggestions may provide one or more alternatives for a partially typed word (e.g. to assist the user, reduce typing errors and/or increasing typing speed) and/or alternative spellings for a mis-typed word (e.g. arranged in one or more lines in the region 118 on the emissive display 102). In examples where the dynamically generated content suggestions are auto-complete suggestions, the user input software 112, 412 generates a plurality of content suggestions based on the same set of user key strokes (in block 306) and these suggestions are presented at the same time to the user so that a user can select none or one of them.

In various examples, the dynamically generated content suggestions may comprise a paste buffer, with each dynamically generated content suggestion corresponding to a different portion of cut/copied content (e.g. text or an image). This therefore provides a graphical representation of the paste buffer which makes it easier for the user to select different elements from the paste buffer, instead of simply being able to paste in the most recently cut/copied content. In this example, a single dynamically generated content suggestion is generated automatically in response to each cut/copy operation, e.g. in response to key strokes such as CTRL and C or CTRL and V, but multiple content suggestions (corresponding to different cut/copy operations) may be presented to the user at the same time so that a user can select none or one of them.

In various examples, the dynamically generated content suggestions may comprise an expansion of well-known, system-defined or user-defined abbreviations. For example, each time a user types an acronym (e.g. GPS, TV, IM, etc.) or common abbreviation (e.g. ‘great’ for ‘g8’ or an image of a smiley face for ‘:)’), the dynamically generated content suggestions may provide one or more suggested expansions for the acronym/abbreviation. These suggestions may be stored within the user input software 112, 412 or a database which is accessible by the user input software 112, 412 (e.g. stored in memory 116, 416) or may be generated by performing a web search using the acronym/abbreviation as the search term.

In various examples, a user may define acronyms/abbreviations and the corresponding expansions and these may be stored in the memory 116, 416. This provides flexibility to the user (e.g. because the expansion does not automatically replace the abbreviation, and so a user can define multiple possible expansions and/or also choose to use an alternative system-defined or well-known expansion) and increases the user's typing speed (e.g. where there are organization or activity specific abbreviations that they wish to use such as PA for ‘Patent Application’ or PO for ‘Patent Office’). In another example, a user may specify that if they type “be”, then a possible expansion of this is “Best regards,” followed by the user's name. In such examples, the user input software 112, 412 may provide a user interface that allows the user to input their own abbreviations and the required expansion(s).

The use of such dynamically generated expansions may increase typing speed and result in clearer content (e.g. avoiding confusion where an acronym/abbreviation has more than one possible meaning). In such examples, one or more content suggestion may be generated for a particular combination of key strokes (e.g. depending upon whether there is more than one possible expansion).

In various examples, the dynamically generated content suggestions may comprise other text, such as a definition of a highlighted word (e.g. where a user may type CTRL D to trigger the display of a definition), an image associated with a highlighted word, etc.

By displaying the automatically generated content on the emissive display, rather than on the electronic paper display 104 on which the keyboard is rendered, the automatically generated content which is presented to the user can be updated more quickly and this improves the usability of the automatically generated content as well as improving the overall user experience (as there is no visible lag in displaying the suggestions). For example, if instead the auto-complete text was displayed on the electronic paper display 104, the user may have finished typing the word before the auto-complete suggestions were rendered (e.g. either all the time or at least some of the time, due to the update rate of the electronic paper display). This renders the auto-complete suggestions obsolete (as they are received too late to be useful) and reduces the user experience.

Using the method of any of FIGS. 3, 7 and 10 (in any of the hardware implementations described) content which is updated regularly is rendered on the display with the higher refresh rate and content which is less frequently updated (e.g. the keyboard itself) is rendered on the display with the lower refresh rate (and lower power consumption).

The visually dynamic user input controls may take forms other than dynamically generated content suggestions and various examples are described below. As with the dynamically generated content suggestions, the visually dynamic user input controls (e.g. as rendered in blocks 204 and 604 in FIGS. 2, 6 and 9) are updated (e.g. in block 208 of FIGS. 2, 6 and 9) based on previously received user inputs (e.g. as received in blocks 206 and 906 in FIGS. 2, 6 and 9).

In any of the examples described above (i.e. the dual display device 100, the covers 300, 400 and the emissive display device 800), the visually dynamic user input controls may, for example, comprise one or more of:
frequently used short-cuts (e.g. Cortana®, search, etc.);
controls for switching between different keyboard layouts;
thumbnails for various search results;
a proper subset of the text editing tools/commands (e.g. those for selecting bold or italics may be considered to be visually static and rendered on the emissive display and those for selecting a text color or font may be considered to be visually dynamic and rendered on the emissive display);
links to related content in different applications (i.e. where the related content relates to the received user inputs); and
links to previous conversation threads to another person (e.g. when drafting an email).

Although many of the examples described herein relate to textual input by the user, the user controls need not relate to textual input. For example, the visually static user controls may comprise controls for a music/video player and the visually dynamic user controls may show thumbnails of album art (e.g. for the particular song or album or related/similar songs) or related videos. The visually dynamic user controls may in addition or alternatively comprise other, dynamic, controls for the music/video player such as a slider for scrolling through the track (where the visually static controls are the controls for stop, play, pause, skip, etc.). Similarly for gaming, the visually static user input controls may provide the standard user input functionality (e.g. left, right, jump) and the dynamic user input controls may provide user input functionality that is only available at certain points in the game or for which the visual representation changes frequently (e.g. where the control displays the number of lives or bullets that a user has left).

In various examples, the visually dynamic user controls may not initially be rendered (e.g. blocks 204 and 604 may be omitted from FIGS. 2, 6 and 9 as indicated by the dotted arrow) but may only be rendered in response to user inputs received via the touch-sensitive electronic paper display (e.g. in blocks 206 and 906 in FIGS. 2, 6 and 9). For example, the proper subset of the text editing tools/commands may appear on the emissive display (e.g. in blocks 210 and 610 in FIGS. 2, 6 and 9) in response to a user touching a particular visually static user input control on the electronic paper display. In another example, the visually static controls (e.g. as rendered in blocks 202 and 902 of FIGS. 2, 6 and 9) may comprise menu names and the visually dynamic user controls may comprise controls within a particular menu and these may be rendered (e.g. in blocks 210 and 610 in FIGS. 2, 6 and 9) in response to a user touching a visually static user input control for a menu on the electronic paper display. By only selectively displaying a menu on the emissive display, valuable space on the emissive display is more generally available for displaying other content.

The processors 108, 408 shown in FIGS. 1, 4, 5 and 8 may be microprocessors, controllers or any other suitable type of processors for processing computer executable instructions to control the operation of the device in order to implement the functionality of any of FIGS. 2, 3, 6, 7, 9 and 10. In some examples, for example where a system on a chip architecture is used, the processors 108, 408 may include one or more fixed function blocks (also referred to as accelerators) which implement a part of the method of any of FIGS. 2, 3, 6, 7, 9 and 10 in hardware (rather than software or firmware). Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The memories 116, 416 shown in FIGS. 1, 4, 5 and 8 comprise any computer-readable media that is accessible by the dual display device 100, cover 400, 500 or emissive display device 800. Computer storage media, such as memory 116, 416, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 116, 416) is shown within the dual display device 100, cover 400, 500 and emissive display device 800 it will be appreciated that the storage may be distributed or located remotely and accessed via a network or other communication link (e.g. using communication interface 410, 804).

In various examples, the user input software 112, 412 may implement other functionality in order to further improve the usability of the keyboard when rendered on the touch-sensitive electronic paper display 104. For example, the dual display device 100, cover 400, 500 or emissive display device 800 may comprise one or more sensors 120 configured to detect the orientation of the device 100, cover 400, 500 or emissive display device 800 (block 314) e.g. when held in a user's hand, and the detected orientation may be used to modify the labels on the rendered keys on the touch-sensitive electronic paper display 104 (block 316), e.g. to correct for perspective and hence make the characters on the soft keys more easily readable for the user.

Although the present examples are described and illustrated herein as being implemented in a system as shown in FIGS. 1, 4, 5 and 8, the systems described are provided as examples and not limitations. As those skilled in the art will appreciate, the present examples are suitable for application in a variety of different types of dual display devices, covers for emissive display devices or emissive display devices themselves and such devices or covers may comprise elements not shown in FIGS. 1, 4, 5 and 8 (e.g. the method of any of FIGS. 2, 3, 6, 7, 9 and 10) may be used in a device which comprises more than two displays. For example, the cover 400 or emissive display device 800 may comprise a kickstand (e.g. as described above with reference to the dual display device 100).

Although the examples shown in FIGS. 1, 4, 5 and 8 all show touch-sensitive displays, as described above in other examples one or both of the displays may not be touch-sensitive. In examples where a display is not touch-sensitive, an alternative user input mechanism is provided to enable a user to select a user input control displayed on that display (e.g. via voice, gestures, mouse, stylus, etc.). Depending upon the particular configuration (e.g. whether it is a dual display device or a removable cover) there may be one user input mechanism for each display (e.g. one in the emissive display device and one in the removable cover or two in a dual display device) or a combined user input mechanism for both displays (e.g. in the dual display example).

Furthermore, although in the examples described above, the visually dynamic user input controls are displayed on a portion of the emissive display which is adjacent to the electronic paper display (where the term ‘adjacent’ does not require the two to be immediately adjacent as there may be a fold, hinge or attachment mechanism which separates the two displays as shown in the figures), in other examples, the visually dynamic user input controls may be displayed on a portion close (but not necessarily adjacent) to the electronic paper display, or in a closest region of the emissive display or in a visually similar region of the emissive display (e.g. if the electronic paper display is smaller than the emissive display, a portion of the emissive display extended along its entire edge may be used, even though not all of the edge is adjacent to the electronic paper display.

A first further example provides a display device comprising: an emissive display; an electronic paper display; and a processor arranged to dynamically split user input controls between the two displays such that visually static user input controls are displayed on the electronic paper display and visually dynamic user input controls are displayed on a portion of the emissive display close to the electronic paper display.

In the first further example, the visually dynamic user input controls may be displayed on a portion of the emissive display adjacent to the electronic paper display.

In the first further example, one or both of the displays may be touch-sensitive.

In the first further example, the display device may further comprise: a memory arranged to store user input software, and wherein the user input software comprises device executable instructions which, when executed by the processor, cause the processor to: dynamically generate an update to a visually dynamic user input control based on a user input corresponding to a user selecting one or more visually static user input controls.

In the first further example, the visually static user input controls may comprise letter keys of a keyboard and the visually dynamic user input controls may comprise dynamically generated and user selectable content suggestions.

In the first further example, the dynamically generated content suggestions may comprise suggested auto-complete words and wherein the user input software may be further arranged to cause the processor to generate the auto-complete words based on user inputs corresponding to a user selecting one or more letter keys.

In the first further example, the dynamically generated content suggestions may comprise one or more suggested expansions of an abbreviation or acronym and wherein the user input software may be further arranged to cause the processor to generate the one or more suggested expansions based on user inputs corresponding to a user selecting one or more letter keys to type the abbreviation or acronym. The abbreviation or acronym may be user-defined.

In the first further example, the one or more dynamically generated content suggestions may comprise a plurality of dynamically generated content suggestions.

In the first further example, the memory may be further arranged to store application software and the user input software may further comprise device executable instructions which, when executed by the processor, cause the processor to: in response to a user selecting a displayed content suggestion, provide the displayed content suggestion as an input to an application running on the display device.

In the first further example, a dynamically generated content suggestion may comprise one or more elements from a paste buffer.

A second further example provides a cover for an emissive display comprising: an electronic paper display; a mechanical arrangement for attaching the emissive display to the cover; a communication interface; and a processor arranged to render visually static user input controls on the electronic paper display and to output data, to the emissive display via the communication interface, to cause visually dynamic user input controls to be rendered on a portion of the emissive display close to the electronic paper display.

In the second further example, the visually dynamic user input controls may be displayed on a portion of the emissive display adjacent to the electronic paper display.

In the second further example, one or both of the displays may be touch-sensitive.

In the second further example, the cover may further comprise: a memory arranged to store user input software, and wherein the user input software may comprise device executable instructions which, when executed by the processor, cause the processor to: dynamically generate an update to one or more dynamic user input controls based on user input received via the visually static user input controls.

In the second further example, the visually static user input controls may comprise letter keys of a keyboard and the visually dynamic user input controls may comprise dynamically generated and user selectable content suggestions.

In the second further example, the one or more dynamically generated content suggestions may comprise suggested auto-complete words for the user input received via the visually static user input controls on which the suggestions are based.

In the second further example, the one or more dynamically generated content suggestions may comprise one or more suggested expansions of an abbreviation or acronym corresponding to the user input received via the visually static user input controls on which the suggestions are based.

In the second further example, the one or more dynamically generated content suggestions may comprise a plurality of dynamically generated content suggestions.

In the second further example, the one or more dynamically generated content suggestions may comprise one or more elements from a paste buffer.

A third further example provides a system comprising an emissive touch-sensitive display device, the emissive touch-sensitive display device comprising: a touch-sensitive emissive display; a mechanical arrangement for attaching a cover to the emissive display, wherein the cover comprises an electronic paper display; a communication interface; and a processor arranged to render visually dynamic user input controls on a portion of the emissive display close to the cover and to output data, to the cover via the communication interface, to cause visually static user input controls to be rendered on the electronic paper display.

In the third further example, the system may further comprise: a memory arranged to store user input software, and wherein the user input software may comprise device executable instructions which, when executed by the processor, cause the processor to: dynamically generate an update to one or more dynamic user input controls based on user input on the visually static user input controls received via the communication interface.

In the third further example, the system may further comprise the cover, the cover comprising: the touch-sensitive electronic paper display; a communication interface configured to receive data from the emissive display device; and driver electronics for the electronic paper display configured to render the visually static user input controls on the electronic paper display using the data received from the emissive display device.

A fourth further example provides a method comprising: rendering visually static user input controls on an electronic paper display; rendering visually dynamic user input controls on a portion of an emissive display which is close to the electronic paper display; in response to receiving user inputs corresponding to a user selecting one or more of the visually static user input controls, dynamically generating updates to the dynamic user input controls based at least in part on the received user inputs; and rendering the updated visually dynamic user input controls on the emissive display.

The method of the fourth further example may be implemented in a dual display device comprising both the electronic paper display and the emissive display.

The method of the fourth further example may further comprise: providing the received user inputs to application software or an operating system running on the dual display device.

In the method of the fourth further example, each visually dynamic user input control may corresponding to a dynamically generated content suggestion and the method further comprising: in response to receiving user inputs corresponding to a user selecting a visually dynamic user input control, providing the received user inputs to application software or an operating system running on the dual display device.

In the method of the fourth further example, one or both of the electronic paper display and the emissive display may be touch-sensitive.

A fifth further example provides a method comprising: rendering visually static user input controls on an electronic paper display; outputting data to enable visually dynamic user input controls to be rendered on a portion of an emissive display which is close to the electronic paper display; in response to receiving user inputs corresponding to a user selecting one or more of the visually static user input controls, dynamically generating updates to the dynamic user input controls based at least in part on the received user inputs; and outputting data to enable rendering of the updated visually dynamic user input controls on the emissive display.

The method of the fifth further example may be implemented in a removable cover for the emissive display device, the removable cover comprising the electronic paper display.

The method of the fifth further example may further comprise: providing the received user inputs to application software or an operating system running on the emissive display.

In the method of the fifth further example, one or both of the electronic paper display and the emissive display may be touch-sensitive.

A sixth further example provides a method comprising: outputting data to enable the rendering of visually static user input controls on an electronic paper display; rendering visually dynamic user input controls on a portion of an emissive display which is close to the electronic paper display; in response to receiving user inputs corresponding to a user selecting one or more of the visually static user input controls, dynamically generating updates to the dynamic user input controls based at least in part on the received user inputs; and rendering the updated visually dynamic user input controls on the emissive display.

The method of the sixth further example may be implemented in an emissive display device comprising the emissive display.

The method of the sixth further example may comprise: providing the received user inputs to application software or an operating system running on the emissive display device.

In the method of the sixth further example, each visually dynamic user input control may correspond to a dynamically generated content suggestion and the method may further comprise: In response to receiving user inputs corresponding to a user selecting a visually dynamic user input control, providing the received user inputs to application software or an operating system running on the emissive display device.

In the method of the sixth further example, one or both of the electronic paper display and the emissive display may be touch-sensitive.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A display device comprising:
an emissive display;
an electronic paper display; and
a processor arranged to dynamically split user input controls between the two displays such that visually static user input controls are displayed on the electronic paper display and visually dynamic user input controls are displayed on a portion of the emissive display close to the electronic paper display.

2. A display device according to claim 1, wherein one or both of the displays are touch-sensitive.

3. A display device according to claim 1, further comprising:
a memory arranged to store user input software,
and wherein the user input software comprises device executable instructions which, when executed by the processor, cause the processor to:
dynamically generate an update to a visually dynamic user input control based on a user input corresponding to a user selecting one or more visually static user input controls.

4. A display device according to claim 3, wherein the visually static user input controls comprise letter keys of a keyboard and the visually dynamic user input controls comprise dynamically generated and user selectable content suggestions.

5. A display device according to claim 4, wherein the dynamically generated content suggestions comprise suggested auto-complete words and wherein the user input software is further arranged to cause the processor to generate the auto-complete words based on user inputs corresponding to a user selecting one or more letter keys.

6. A display device according to claim 4, wherein the dynamically generated content suggestions comprise one or more suggested expansions of an abbreviation or acronym and wherein the user input software is further arranged to cause the processor to generate the one or more suggested expansions based on user inputs corresponding to a user selecting one or more letter keys to type the abbreviation or acronym.

7. A display device according to claim 6, wherein the abbreviation or acronym is user-defined.

8. A display device according to claim 4, wherein the one or more dynamically generated content suggestions comprises a plurality of dynamically generated content suggestions.

9. A display device according to claim 4, wherein the memory is further arranged to store application software and the user input software further comprises device executable instructions which, when executed by the processor, cause the processor to:
in response to a user selecting a displayed content suggestion, provide the displayed content suggestion as an input to an application running on the display device.

10. A dual display device according to claim 4, wherein a dynamically generated content suggestion comprises one or more elements from a paste buffer.

11. A cover for an emissive display comprising:
an electronic paper display;
a mechanical arrangement for attaching the emissive display to the cover;
a communication interface; and
a processor arranged to render visually static user input controls on the electronic paper display and to output data, to the emissive display via the communication interface, to cause visually dynamic user input controls to be rendered on a portion of the emissive display close to the electronic paper display.

12. A cover according to claim 11, wherein one or both of the displays are touch-sensitive.

13. A cover according to claim 11, further comprising:
a memory arranged to store user input software,
and wherein the user input software comprises device executable instructions which, when executed by the processor, cause the processor to:
dynamically generate an update to one or more dynamic user input controls based on user input received via the visually static user input controls.

14. A cover according to claim 12, wherein the visually static user input controls comprise letter keys of a keyboard and the visually dynamic user input controls comprise dynamically generated and user selectable content suggestions.

15. A cover according to claim 13, wherein the one or more dynamically generated content suggestions comprise suggested auto-complete words for the user input received via the visually static user input controls on which the suggestions are based.

16. A cover according to claim 13, wherein the one or more dynamically generated content suggestions comprise one or more suggested expansions of an abbreviation or acronym corresponding to the user input received via the visually static user input controls on which the suggestions are based.

17. A cover according to claim 13, wherein the one or more dynamically generated content suggestions comprises a plurality of dynamically generated content suggestions or one or more elements from a paste buffer.

18. A system comprising an emissive touch-sensitive display device, the emissive touch-sensitive display device comprising:
a touch-sensitive emissive display;
a mechanical arrangement for attaching a cover to the emissive display, wherein the cover comprises an electronic paper display;
a communication interface; and
a processor arranged to render visually dynamic user input controls on a portion of the emissive display close to the cover and to output data, to the cover via the communication interface, to cause visually static user input controls to be rendered on the electronic paper display.

19. A system according to claim 18, further comprising:
a memory arranged to store user input software,
and wherein the user input software comprises device executable instructions which, when executed by the processor, cause the processor to:
dynamically generate an update to one or more dynamic user input controls based on user input on the visually static user input controls received via the communication interface.

20. A system according to claim 18, further comprising the cover, the cover comprising:
the touch-sensitive electronic paper display;
a communication interface configured to receive data from the emissive display device; and
driver electronics for the electronic paper display configured to render the visually static user input controls on the electronic paper display using the data received from the emissive display device.
